(19) United States
(12) Patent Application Publication
(10) Pub. No.: US 2024/0368316 A1
(43) Pub. Date: Nov. 7, 2024

(54) CHLORINATED VINYL-CHLORIDE-BASED RESIN, RESIN COMPOSITION FOR MOLDING, AND MOLDED OBJECT

(71) Applicant: Sekisui Chemical Co., Ltd., Osaka (JP)

(72) Inventors: Kento MURAKAMI, Yamaguchi (JP); Takuya SAWAI, Yamaguchi (JP); Yoshito ARAI, Osaka (JP)

(73) Assignee: Sekisui Chemical Co., Ltd., Osaka (JP)

(21) Appl. No.: 18/689,536

(22) PCT Filed: Sep. 22, 2022
(86) PCT No.: PCT/JP2022/035421

§ 371 Date: Mar. 6, 2024

(30) Foreign Application Priority Data
Sep. 24, 2021 (JP) 2021-155981

(51) Int. Cl. C08F 14/06; C08F 8/22

(52) U.S. Cl. CPC C08F 14/06; C08F 8/22

(57) ABSTRACT

The present invention provides a chlorinated polyvinyl chloride resin, a resin composition for molding, and a molded body that are capable of suppressing a change in thickness and a decrease in impact resistance when contacting acidic liquid. Provided is a chlorinated polyvinyl chloride resin having a ratio (A/B) of a symmetry factor A to a symmetry factor B of 2.61 or greater and 4.50 or less in high-performance liquid chromatography measurement, the symmetry factor A being a symmetry factor of a peak observed in a retention time range from 2 to 4 minutes, the symmetry factor B being a symmetry factor of a peak observed in a retention time range from 10 to 18 minutes.

### TECHNICAL FIELD

The present invention relates to chlorinated polyvinyl chloride resins, resin compositions for molding, and molded bodies.

### BACKGROUND ART

Polyvinyl chloride resins generally have excellent mechanical strength and weather resistance, and thus are processed into various molded bodies and used in various fields.

As polyvinyl chloride resins have poor heat resistance, chlorinated polyvinyl chloride resins (CPVCs), which are polyvinyl chloride resins chlorinated to improve their heat resistance, have been developed.

For example, Patent Literature 1 discloses a chlorinated polyvinyl chloride resin obtained by a specific production method. Patent Literature 1 discloses that such a resin causes less initial discoloration when thermally molded, and has excellent thermal stability.

### CITATION LIST

### Patent Literature

Patent Literature 1: WO 2014/178362

### SUMMARY OF INVENTION

### Technical Problem

However, products molded using the chlorinated polyvinyl chloride resin disclosed in Patent Literature 1 may have poor impact resistance, and may undergo a change in thickness or a great decrease in impact resistance especially when subjected to high-temperature, high-pressure conditions or when contacting acidic liquid or the like.

In view of the technical problems in the prior art, the present invention aims to provide a chlorinated polyvinyl chloride resin, a resin composition for molding, and a molded body that are capable of suppressing a change in thickness and a decrease in impact resistance when contacting acidic liquid at high temperature and high pressure.

### Solution to Problem

The present disclosure (1) relates to a chlorinated polyvinyl chloride resin having a ratio (A/B) of a symmetry factor A to a symmetry factor B of 2.61 or greater and 4.50 or less in high-performance liquid chromatography measurement, the symmetry factor A being a symmetry factor of a peak observed in a retention time range from 2 to 4 minutes, the symmetry factor B being a symmetry factor of a peak observed in a retention time range from 10 to 18 minutes.

The present disclosure (2) relates to the chlorinated polyvinyl chloride resin according to the present disclosure (1), including perchlorinated units in an amount of 23.0 mol % or more and 65.0 mol % or less.

The present disclosure (3) relates to the chlorinated polyvinyl chloride resin according to the present disclosure (1) or (2), containing added chlorine in an amount of 3.3% by mass or more and 15.3% by mass or less. The present disclosure (4) relates to the chlorinated polyvinyl chloride resin according to any one of the present disclosures (1) to (3), having a C calculated by the following formula (1) of 7.0 or greater and 25.0 or less:

C=(Amount of added chlorine)^{1/3}×(Symmetry factor A)² (1).

The present disclosure (5) relates to a resin composition for molding, containing the chlorinated polyvinyl chloride resin according to any one of the present disclosures (1) to (4).

The present disclosure (6) relates to a molded body produced using the resin composition for molding according to the present disclosure (5).

The present invention is described in detail below.

The chlorinated polyvinyl chloride resin of the present invention has a ratio of a symmetry factor A to a symmetry factor B (A/B, hereinafter also referred to as a symmetry factor ratio) of 2.61 or greater and 4.50 or less in high-performance liquid chromatography measurement, the symmetry factor A being a symmetry factor of a peak observed in a retention time range from 2 to 4 minutes, the symmetry factor B being a symmetry factor of a peak observed in a retention time range from 10 to 18 minutes.

With the symmetry factor ratio within the range, the chlorinated polyvinyl chloride resin can achieve excellent impact resistance even when used in an application in which the resin contacts acidic liquid at high temperature and high pressure. The chlorinated polyvinyl chloride resin in the present invention particularly can maintain desired properties even under conditions severer than those of contacting acidic liquid or the like (chemical resistance).

The symmetry factor ratio is preferably 2.84 or greater and 4.24 or less, more preferably 2.94 or greater and 3.84 or less, still more preferably 3.09 or greater and 3.44 or less. The symmetry factor ratio (A/B) can be measured by the following method.

The symmetry factors A and B are symmetry factors (W_{0.05h}/2f) based on JIS K 0124 (2011), measured by reversed-phase partition gradient high-performance liquid chromatography using an acetonitrile-tetrahydrofuran eluent.

The definitions of “W_{0.05h}” and “f” herein are in conformity with JIS K 0124 (2011). Specifically, “W_{0.05h}” represents the peak width at 1/20 of the peak height from the peak baseline. “f” represents the distance from the peak start point to the point where a perpendicular line drawn from the peak top to the horizontal axis bisects the peak width W_{0.05h}. Here, W_{0.05h} and f are expressed in the same unit.

Here, the symmetry factor represents the degree of symmetry of a measurement peak obtained by high-performance liquid chromatography. FIG. 1 shows an example of HPLC measurement results. In FIG. 1, the symmetry factor (W_{0.05h}/2f) is calculated using the peak width (W_{0.05h}) at 1/20 (5%) of the height of an obtained measurement peak and the distance (f) from the peak start point at this peak width to the intersection of a horizontal line passing through the peak start point and a perpendicular line passing through the peak top.

Here, f is the distance between x and y in FIG. 1. In other words, f is the distance from a peak start point x at 5% height of a measurement peak in HPLC analysis to an intersection y of a horizontal line passing through the peak start point and a perpendicular line passing through the peak top (i.e., the distance from the leading edge of the peak to the point where the perpendicular line passing through the peak top bisects the peak width at the 5% height). In FIG. 1, the dotted line parallel to the horizontal axis represents the baseline, and x represents a peak start point. A symmetry factor closer to 1.0 indicates a higher degree of peak symmetry.

When the chlorinated polyvinyl chloride resin is subjected to high-performance liquid chromatography measurement, two peaks are detected: one in a retention time range from 2 to 4 minutes and the other in a retention time range from 10 to 18 minutes. The symmetry factor of the peak observed in the retention time range from 2 to 4 minutes is defined as a “symmetry factor A”. The symmetry factor of the peak observed in the retention time range from 10 to 18 minutes is defined as a “symmetry factor B”. They are used to calculate the ratio (A/B) of the symmetry factor A to the symmetry factor B.

In the present invention, the high-performance liquid chromatography measurement is performed as follows.

Different types of liquid with different polarities are used for the mobile phase. Liquid such as acetonitrile is used as a high-polarity mobile phase a, and liquid such as tetrahydrofuran is used as a low-polarity mobile phase b. Before sample injection, the inside of the column of the HPLC system is filled with a solvent mixture at a mobile phase a/mobile phase b volume ratio of 7/3. The sample is injected into the column in this state. From immediately after the sample injection, the proportion of the mobile phase b in the mobile phase is increased at a constant rate (5 vol %/min) over 12 minutes. From 12 minutes after the sample injection (at this time, the mobile phase is completely replaced with the mobile phase b), the mobile phase b is run for 6 minutes.

The HPLC column may be a C8 silica column. for example.

In the chlorinated polyvinyl chloride resin of the present invention, the symmetry factor A of the peak observed in the retention time range from 2 to 4 minutes in the high-performance liquid chromatography measurement is preferably 2.27 or greater and 3.09 or less. The symmetry factor A is more preferably 2.41 or greater and 2.91 or less, still more preferably 2.81 or greater and 2.89 or less.

In the chlorinated polyvinyl chloride resin of the present invention, the symmetry factor B of the peak observed in the retention time range from 10 to 18 minutes in the high-performance liquid chromatography measurement is preferably 0.65 or greater and 0.95 or less. The symmetry factor B is more preferably 0.74 or greater and 0.86 or less, still more preferably 0.76 or greater and 0.81 or less.

The chlorinated polyvinyl chloride resin of the present invention preferably has a ratio (AW_{0.5}/BW_{0.5}) of a half width AW_{0.5} to a half width BW_{0.5} of 0.31 or greater and 0.66 or less in high-performance liquid chromatography measurement, the half width AW_{0.5} being a half width of a peak observed in a retention time range from 2 to 4 minutes, the half width BW_{0.5} being a half width of a peak observed in a retention time range from 10 to 18 minutes. The AW_{0.5}/BW_{0.5} is also referred to as a half width ratio.

With the half width ratio within the range, the chlorinated polyvinyl chloride resin can achieve excellent impact resistance even in an application in which the resin contacts acidic liquid at high temperature and high pressure.

The half width ratio is more preferably 0.36 or greater and 0.58 or less.

The half width means the peak width (W_{0.5}) at ½ (50%) of the height of an observed peak.

In the chlorinated polyvinyl chloride resin of the present invention, the half width AW_{0.5} of the peak observed in the retention time range from 2 to 4 minutes in the high-performance liquid chromatography measurement is preferably 0.18 or greater and 0.30 or less. The half width AW_{0.5} is more preferably 0.19 or greater and 0.27 or less.

In the chlorinated polyvinyl chloride resin of the present invention, the half width BW_{0.5} of the peak observed in the retention time range from 10 to 18 minutes in the high-performance liquid chromatography measurement is preferably 0.30 or greater and 0.80 or less. The half width BW_{0.5} is more preferably 0.32 or greater and 0.65 or less.

The chlorinated polyvinyl chloride resin of the present invention preferably has a D of 2.36 or greater and 2.70 or less, where the D is calculated by the following formula (2) based on the symmetry factor A and the symmetry factor B. The D is more preferably 2.40 or greater and 2.60 or less. With the D in the range, the chlorinated polyvinyl chloride resin can suppress a change in thickness and a decrease in impact resistance when contacting acidic liquid at high temperature and high pressure.

D=(Symmetry factor B)+(Symmetry factor A)^{1/2} (2)

The chlorinated polyvinyl chloride resin of the present invention includes vinyl chloride units and perchlorinated units. Such a chlorinated polyvinyl chloride resin can suppress a change in thickness and a decrease in impact resistance when contacting acidic liquid at high temperature and high pressure. The vinyl chloride unit refers to a structural unit derived from a polyvinyl chloride resin before chlorination. The perchlorinated unit refers to a structural unit newly formed by chlorination.

The effects of the chlorinated polyvinyl chloride resin of the present invention are not solely due to the structures of the vinyl chloride units and the perchlorinated units.

In the chlorinated polyvinyl chloride resin of the present invention, the amount of the vinyl chloride units is preferably 7.0 mol % or more, more preferably 32.0 mol % or more and is preferably 92.0 mol % or less, more preferably 62.0 mol % or less.

The vinyl chloride units include a structural unit represented by the following formula (a) and a structural unit represented by the following formula (b).

The amount of the vinyl chloride units is the amount relative to the entire chlorinated polyvinyl chloride resin of the present invention.

The amount of the structural unit represented by the following formula (b) is preferably 0.001 mol % or more and 1 mol % or less, more preferably 0.1 mol % or more and 0.9 mol % or less, relative to the entire chlorinated polyvinyl chloride resin of the present invention.

[Chem. 1]

—CH₂—CHCl— (a)

—CH═CCl— (b)

In the chlorinated polyvinyl chloride resin of the present invention, the amount of the perchlorinated units is preferably 23.0 mol % or more, more preferably 33.0 mol % or more and is preferably 65.0 mol % or less, more preferably 60.0 mol % or less.

The perchlorinated units include structural units represented by the following formulas (c) to (e).

The amount of the perchlorinated units is the amount relative to the entire chlorinated polyvinyl chloride resin of the present invention.

The amount of the structural unit represented by the following formula (e) is preferably 1.0 mol % or more and 1.5 mol % or less, more preferably 1.1 mol % or more and 1.4 mol % or less, relative to the entire chlorinated polyvinyl chloride resin of the present invention.

[Chem. 2]

—CH₂—CCl₂— (c)

—CHCl—CHCl— (d)

—CCl═CCl— (e)

The chlorinated polyvinyl chloride resin of the present invention may include other structural units in addition to the vinyl chloride units and perchlorinated units, as long as the effects of the present invention are not impaired.

The amount of other structural units is preferably 0.1 mol % or more and 25 mol % or less, more preferably 0.2 mol % or more and 20 mol % or less in the chlorinated polyvinyl chloride resin.

Examples of other structural units include those represented by the following formulas (f), (g), and (h). In the formula (f), X represents a hydrogen atom or a chlorine atom. The formula (h) shows an end structure.

[Chem. 3]

—CX—(C═O)— (f)

—CH(CH₂Cl)— (g)

—CH₂—Cl (h)

The amounts of the vinyl chloride units, the perchlorinated units, and other structural units in the chlorinated polyvinyl chloride resin of the present invention can be measured by molecular structure analysis using NMR. The NMR analysis can be performed in conformity with the method described in R. A. Komoroski, R. G. Parker, J. P. Shocker, Macromolecules, 1985, 18, 1257-1265.

The chlorinated polyvinyl chloride resin of the present invention preferably contains added chlorine in an amount of 3.3 to 15.3% by mass.

With an amount of added chlorine of 3.3% by mass or more, a molded article to be obtained has sufficient heat resistance. With an amount of added chlorine of 15.3% by mass or less, moldability is improved.

The amount of added chlorine is more preferably 5.3% by mass or more, still more preferably 8.2% by mass or more. The amount is more preferably 12.3% by mass or less, still more preferably 11.2% by mass or less.

A polyvinyl chloride resin typically has a chlorine content of 56.8% by mass. The amount of added chlorine means the proportion of chlorine introduced into a polyvinyl chloride resin, and can be measured by the method specified in JIS K 7229.

The chlorinated polyvinyl chloride resin of the present invention preferably has a C calculated by the following formula (1) of 7.0 or greater and 25.0 or less. The C is more preferably 10.0 or greater and 19.0 or less. With the C within the range, the chlorinated polyvinyl chloride resin can suppress a change in thickness and a decrease in impact resistance when contacting acidic liquid at high temperature and high pressure.

C=(Amount of added chlorine)^{1/3}×(Symmetry factor A)² (1)

The chlorinated polyvinyl chloride resin of the present invention may have any average degree of polymerization. It is preferably 400 or greater, more preferably 500 or greater and is preferably 2,000 or less, more preferably 1,500 or less.

With the average degree of polymerization within the range, the fluidity in injection and the strength of a molded article can be both achieved.

The degree of polymerization herein is in conformity with JIS-K-6721 and refers to an average degree of polymerization calculated from the specific viscosity.

The chlorinated polyvinyl chloride resin of the present invention preferably has a E calculated by the following formula (3) of 22.0 or greater and 50.0 or less. The E is more preferably 24.0 or greater and 43.0 or less. With the E within the range, the chlorinated polyvinyl chloride resin can suppress a change in thickness and a decrease in impact resistance when contacting acidic liquid at high temperature and high pressure.

E=[Symmetry factor ratio (A/B)]+(Average degree of polymerization)^{1/2} (3)

The chlorinated polyvinyl chloride resin of the present invention is a resin obtained by the chlorination of a polyvinyl chloride resin.

The polyvinyl chloride resin used may be a vinyl chloride homopolymer or may be a copolymer of a vinyl chloride monomer and a monomer with unsaturated bond(s) that is copolymerizable with the vinyl chloride monomer, a graft copolymer obtained by graft-copolymerizing a vinyl chloride monomer to a polymer, or the like. These polymers may be used singly or in combinations of two or more.

When the polyvinyl chloride resin is a copolymer of a vinyl chloride monomer and a monomer with unsaturated bond(s) that is copolymerizable with the vinyl chloride monomer, or a graft copolymer obtained by graft-copolymerizing a vinyl chloride monomer to a polymer, the amount of a component derived from the vinyl chloride monomer in the polyvinyl chloride resin is preferably 90% by mass or more and preferably 100% by mass or less.

Examples of the monomer with unsaturated bond(s) that is copolymerizable with the vinyl chloride monomer include α-olefins, vinyl esters, vinyl ethers, (meth)acrylates, aromatic vinyls, vinyl halides, and N-substituted maleimides. These monomers may be used singly or in combinations of two or more.

Examples of the α-olefins include ethylene, propylene, and butylene. Examples of the vinyl esters include vinyl acetate and vinyl propionate. Examples of the vinyl ethers include butyl vinyl ether and cetyl vinyl ether.

Examples of the (meth)acrylates include methyl (meth)acrylate, ethyl (meth)acrylate, butyl acrylate, and phenyl methacrylate. Examples of the aromatic vinyls include styrene and α-methyl styrene.

Examples of the vinyl halides include vinylidene chloride and vinylidene fluoride. Examples of the N-substituted maleimides include N-phenyl maleimide and N-cyclohexyl maleimide.

Preferred among these are ethylene and vinyl acetate.

The polymer to which vinyl chloride is graft copolymerized is not limited as long as vinyl chloride can be graft copolymerized. Examples of such a polymer include ethylene-vinyl acetate copolymers, ethylene-vinyl acetate-carbon monoxide copolymers, ethylene-ethyl acrylate copolymers, ethylene-butyl acrylate-carbon monoxide copolymers, ethylene-methyl methacrylate copolymers, and ethylene-propylene copolymers. Examples also include acrylonitrile-butadiene copolymers, polyurethane, chlorinated polyethylene, and chlorinated polypropylene. These may be used singly or in combination of two or more.

The method of polymerizing the polyvinyl chloride resin is not limited. A conventionally known method can be used such as aqueous suspension polymerization, bulk polymerization, solution polymerization, or emulsion polymerization.

The chlorinated polyvinyl chloride resin of the present invention may be produced, for example, by a method including suspending a polyvinyl chloride resin in an aqueous medium in a reaction vessel to prepare a suspension, introducing chlorine into the reaction vessel, and heating the suspension to chlorinate the polyvinyl chloride resin.

The symmetry factor ratio (A/B) can be adjusted by changing the structure of the chlorinated polyvinyl chloride resin as well as the conditions in chlorination of the polyvinyl chloride resin such as pressure, temperature, chlorine concentration, chlorine dioxide concentration, hydrogen peroxide concentration, chlorine consumption rate, stirring conditions (e.g., baffle distance/impeller size, uniformity of kinetic energy per volume), light energy irradiation intensity, and light wavelength.

The reaction vessel used may be a commonly used vessel such as a glass-lined stainless steel reaction vessel or a titanium reaction vessel, for example.

The reaction vessel is preferably equipped with a baffle. The baffle is a plate-shaped member disposed on the inner wall of the reaction vessel to redirect the flow of the reaction liquid that occurs when the impeller stirs the liquid. The baffle disrupts and redirects a swirling flow of the reaction liquid within the reaction vessel, thus promoting the generation of a circulating flow in the reaction vessel.

The method of preparing the suspension of the polyvinyl chloride resin in an aqueous medium is not limited. For example, a cake-like PVC obtained by subjecting a polymerized PVC to monomer removal treatment may be used, or a dried PVC may be resuspended in an aqueous medium, or a suspension obtained by removing any substance undesired for the chlorination reaction from the polymerization system may be used. It is preferred to use a cake-like resin obtained by subjecting a polymerized PVC to monomer removal treatment.

The aqueous medium used may be ion-exchange-treated pure water, for example. While the amount of the aqueous medium is not limited, generally, it is preferably 150 to 400 parts by mass based on 100 parts by mass of the PVC.

Chlorine to be introduced into the reaction vessel may be either liquid chlorine or gaseous chlorine. The use of liquid chlorine is efficient in that a large amount of chlorine can be charged into the reaction vessel in a short period of time. Chlorine may be added in the course of reaction to adjust the pressure or supply chlorine. At this time, gaseous chlorine in addition to liquid chlorine may be blown into the reaction vessel, as required.

While the gauge pressure in the reaction vessel in the chlorination step is not limited, it is preferably from 0 to 2 MPa because the higher the chlorine pressure is, the more readily the chlorine will penetrate into the PVC particles.

The method of chlorinating the PVC in the suspended state is not limited. Examples of the chlorination method include a method in which the excitation of bonding of the PVC and chlorine is brought about by thermal energy to accelerate the chlorination (hereinafter referred to as thermal chlorination) and a method in which irradiation with light energy such as UV light is performed to accelerate the chlorination by photoreaction (hereinafter referred to as photo-chlorination). The heating method in the chlorination by thermal energy is not limited, and for example, heating with an external jacket from the reactor wall is effective. The use of light energy such as ultraviolet light requires an apparatus capable of light energy irradiation such as ultraviolet irradiation under high-temperature and high-pressure conditions. For photo-chlorination, the chlorination reaction temperature is preferably 40° C. to 80° C. For the photo-chlorination, the ratio of the irradiation intensity (W) of the light energy to the total amount (kg) of raw material PVC and water is preferably 0.001 to 6 (W/kg), and the wavelength of the irradiation light is preferably 280 to 420 nm.

Preferred among the chlorination methods above are thermal chlorination and photo-chlorination. A preferred method for thermal chlorination is to excite the bonding of the polyvinyl chloride resin and chlorine by heat alone or by heat and hydrogen peroxide to accelerate the chlorination reaction.

The chlorination by heating alone is preferably performed at a temperature within the range of 40° C. to 120° C. At an excessively low temperature, the speed of chlorination will decrease. At an excessively high temperature, dehydrochlorination reaction will occur along with the chlorination reaction, which may cause discoloration of the resulting CPVC. The heating temperature is more preferably within the range of 50° C. to 110° C. The heating method is not limited, and heating may be performed with an external jacket from the reaction vessel wall, for example.

In the chlorination, preferably, hydrogen peroxide is further added to the suspension. Adding hydrogen peroxide can improve the speed of chlorination. The hydrogen peroxide is added preferably in an amount of 5 to 500 ppm relative to the PVC per hour of reaction time. Adding too little hydrogen peroxide may not provide the effect of improving the speed of chlorination. Adding too much hydrogen peroxide may decrease the thermal stability of the CPVC.

When the hydrogen peroxide is added, the heating temperature can be relatively low because the hydrogen peroxide improves the speed of chlorination. The heating temperature may be within the range of 65° C. to 110° C., for example.

During the chlorination, it is preferred to perform chlorination at a chlorine consumption rate of 0.010 to 0.015 kg/PVC-Kg·5 min after the amount of added chlorine reaches a value that is five percentage points by mass lower than the final amount of added chlorine, and further perform chlorination at a chlorine consumption rate of 0.005 to 0.010 kg/PVC-Kg·5 min after the amount of added chlorine reaches a value that is three percentage points by mass lower than the final amount of added chlorine. As used herein, the term “chlorine consumption rate” refers to the amount of chlorine consumed in 5 minutes per kilogram of the raw material PVC.

Chlorination by the above method can produce a CPVC with less nonuniformity in the chlorinated state and with excellent thermal stability.

With the chlorination method, chlorination is preferably performed while stirring the suspension. The suspension is preferably stirred under such conditions that the uniformity of kinetic energy per volume is 0.31 to 0.45 kg/m/s².

With a uniformity of kinetic energy per volume of 0.31 kg/m/s² or greater, chlorine in the gas phase portion in the reactor can be sufficiently taken in the liquid phase portion. With a uniformity of kinetic energy per volume of 0.45 kg/m/s² or less, chlorine taken in the liquid phase portion is less likely to be released back into the gas phase portion, thus allowing chlorination with less variation.

The uniformity of kinetic energy per volume can be calculated using thermal fluid/powder analysis software “R-FLOW” (available from R-flow Corporation, Ltd.), for example.

Specifically, the height from the lowermost point of the reaction vessel to the liquid surface is trisected, and the region corresponding to the upper one-third of the height is defined as an upper layer portion, whereas the region corresponding to the lower one-third of the height is defined as a lower layer portion. The uniformity of kinetic energy per volume can be determined by determining the difference in kinetic energy per volume between the upper layer portion and the lower layer portion.

The impeller preferably has a rotation rate in of 10 to 500 rpm in stirring, and the reaction vessel preferably has a capacity of 0.01 m³ to 100 m³.

The height of the impeller is preferably adjusted such that the ratio of the distance from the liquid surface to the impeller to the height of the liquid surface (distance from liquid surface to impeller/height of liquid surface) in stirring is 0.05 to 0.70 (m/m). The height of the liquid surface means the distance from the bottom of the reaction vessel to the raw material liquid surface when the raw materials are fed to the reaction vessel. The distance from the liquid surface to the impeller means the distance from the liquid surface to the uppermost portion of the impeller.

The reaction vessel in stirring preferably has a baffle distance of 241 to 600 mm.

The baffle distance refers to the distance form the lowermost point of the baffle disposed in the reaction vessel to the uppermost point of the impeller. FIG. 2 is a schematic view of a reaction vessel equipped with a stirrer having an impeller and a baffle. A baffle distance X is the distance from a lowermost point a of the baffle disposed in the reaction vessel to an uppermost point b of the impeller. The lowermost point a of the baffle means a portion at the bottom and center of the baffle. The uppermost point b of the impeller means a portion at which the impeller intersects the shaft.

The ratio of the baffle distance to the impeller size (baffle distance/impeller size) is preferably 0.634 (mm/mm) or greater and 1.58 (mm/mm) or less.

The ratio of the impeller size to the reaction vessel diameter (impeller size/reaction vessel diameter) is preferably 0.3 (m/m) or greater and 0.9 (m/m) or less.

With the chlorination method, the chlorine introduced into the reaction vessel preferably has a concentration of 95% or higher.

With the chlorination method, the chlorine dioxide concentration in the reaction vessel is preferably 5,000 ppm or less, more preferably 2,500 ppm or less relative to the mass of the introduced chlorine. The lower limit of the chlorine dioxide concentration is not limited but is preferably 0.1 ppm or more, preferably 1 ppm or more.

With the chlorination method, stabilized chlorine dioxide may be fed as an additive, or chlorine gas containing chlorine dioxide may be used.

A molded body can be produced by molding a resin composition for molding containing the chlorinated polyvinyl chloride resin of the present invention.

The present invention also encompasses a resin composition for molding containing the chlorinated polyvinyl chloride resin of the present invention.

The lower limit of the amount of the chlorinated polyvinyl chloride resin of the present invention in the resin composition for molding of the present invention is preferably 65% by mass, more preferably 70% by mass, and the upper limit thereof is preferably 96% by mass, more preferably 93% by mass.

The resin composition for molding of the present invention may optionally contain additives such as stabilizers, lubricants, processing aids, impact resistance modifiers, heat resistance improvers, antioxidants, ultraviolet absorbents, light stabilizers, fillers, thermoplastic elastomers, and pigments.

Examples of the stabilizers include, but are not limited to, thermal stabilizers and thermal stabilization aids. Examples of the thermal stabilizers include, but are not limited to, organotin stabilizers, lead stabilizers, calcium-zinc stabilizers, barium-zinc stabilizers, and barium-cadmium stabilizers.

Examples of the organotin stabilizers include dibutyl tin mercapto, dioctyl tin mercapto, dimethyl tin mercapto, dibutyl tin mercapto, dibutyl tin maleate, dibutyl tin maleate polymers, dioctyl tin maleate, dioctyl tin maleate polymers, dibutyl tin laurate, and dibutyl tin laurate polymers.

Examples of the lead stabilizers include lead stearate, dibasic lead phosphite, and tribasic lead sulfate. These may be used singly or in combination of two or more thereof.

Examples of the thermal stabilization aids include, but are not limited to, epoxidized soybean oil, phosphate, polyol, hydrotalcite, and zeolite. These may be used singly or in combination of two or more thereof.

Examples of the lubricants include internal lubricants and external lubricants.

Internal lubricants are used to reduce the fluid viscosity of the molten resin in molding to prevent the generation of frictional heat. Examples of the internal lubricants include, but are not limited to, butyl stearate, lauryl alcohol, stearyl alcohol, epoxidized soybean oil, glycerol monostearate, stearic acid, and bisamide. These may be used singly or in combinations of two or more.

External lubricants are used to improve the slip effect between metal surfaces and the molten resin in molding. Examples of the external lubricants include, but are not limited to, paraffin wax, polyolefin waxes, ester waxes, and montanic acid wax. These may be used singly or in combinations of two or more.

Examples of the processing aids include, but are not limited to, acrylic processing aids such as alkyl acrylate-alkyl methacrylate copolymers having a mass average molecular weight of 100,000 to 2,000,000. Examples of the acrylic processing aids include, but are not limited to, n-butyl acrylate-methyl methacrylate copolymers and 2-ethylhexyl acrylate-methyl methacrylate-butyl methacrylate copolymers. These may be used singly or in combination of two or more thereof.

Examples of the impact resistance modifiers include, but are not limited to, methyl methacrylate-butadiene-styrene copolymers (MBS), chlorinated polyethylene, and acrylic rubber.

Examples of the heat resistance improvers include, but are not limited to, α-methylstyrene resins and N-phenylmaleimide resins.

Examples of the antioxidants include, but are not limited to, phenolic antioxidants.

Examples of the light stabilizers include, but are not limited to, hindered amine light stabilizers.

Examples of the ultraviolet absorbents include, but are not limited to, salicylate ultraviolet absorbents, benzophenone ultraviolet absorbents, benzotriazole ultraviolet absorbents, and cyanoacrylate ultraviolet absorbents.

Examples of the fillers include, but are not limited to, calcium carbonate and talc.

Examples of the pigments include, but are not limited to, organic pigments such as azo pigments, phthalocyanine pigments, threne pigments, and dye lake pigments; and inorganic pigments such as oxide pigments, molybdenum chromate pigments, sulfide/selenide pigments, and ferrocyanide pigments.

Moreover, a molded body molded from the resin composition for molding of the present invention is provided. The present invention also encompasses such a molded body.

The molding method may be any conventionally known molding method, for example, extrusion molding or injection molding.

The molded body of the present invention can suppress a change in thickness and a decrease in impact resistance when contacting acidic liquid at high temperature and high pressure. The molded body thus can be suitably used in applications such as building components, plumbing materials and equipment, and housing materials.

### Advantageous Effects of Invention

The present invention can provide a chlorinated polyvinyl chloride resin, a resin composition for molding, and a molded body that are capable of suppressing a change in thickness and a decrease in impact resistance when contacting acidic liquid at high temperature and high pressure.

### BRIEF DESCRIPTION OF DRAWINGS

FIG. 1 shows exemplary peaks obtained in HPLC measurement.

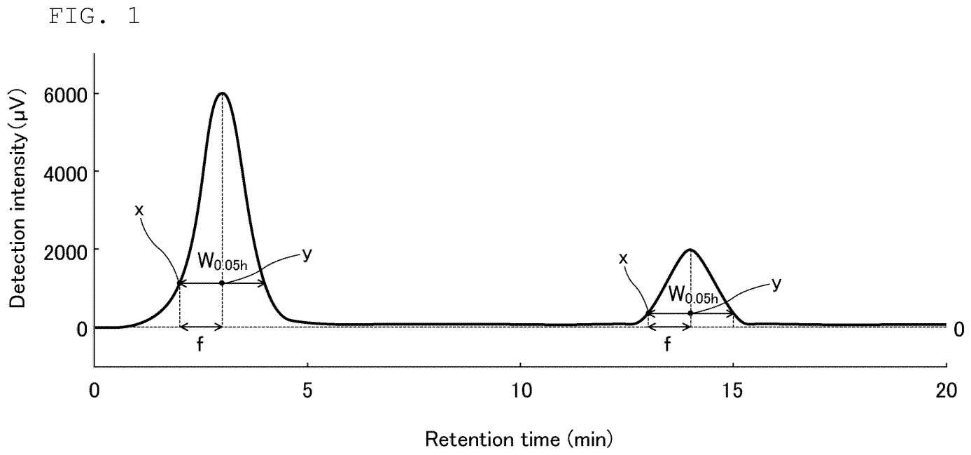

FIG. 2 is a schematic view of a reaction vessel equipped with a stirrer having a impeller and a baffle.

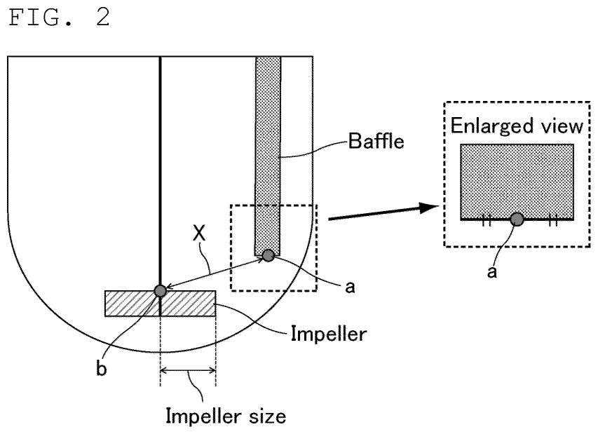

### DESCRIPTION OF EMBODIMENTS

The present invention is hereinafter described in more detail with reference to examples; however, the present invention should not be limited to these examples.

### EXAMPLE 1

A glass-lined reaction vessel having an inner capacity of 300 L was charged with 130 kg of ion-exchanged water, 50 kg of a polyvinyl chloride resin having an average degree of polymerization of 700, and stabilized chlorine dioxide. They were stirred to disperse the polyvinyl chloride resin in water to prepare an aqueous suspension, and then the inside of the reaction vessel was heated to raise the temperature of the aqueous suspension to 100° C. The stabilized chlorine dioxide was added in such a proportion that the amount of chlorine dioxide was 200 ppm relative to the mass of the chlorine introduced in chlorination. Subsequently, the oxygen was removed (oxygen content 100 ppm) by reducing the pressure in the reaction vessel, and then chlorine was introduced at a partial pressure of chlorine of 0.40 MPa, while stirring using a impeller at a uniformity of kinetic energy per volume in stirring of 0.380 kg/m/s². Thus, thermal chlorination was started. The reaction vessel was equipped with a baffle, and the ratio of the baffle distance to the impeller size (baffle distance/impeller size) in stirring was 1.107 (mm/mm).

Then, the chlorination temperature was kept at 100° C., and the partial pressure of chlorine was kept at 0.40 MPa. After the amount of added chlorine reached 4.2% by mass, addition of a 200 ppm hydrogen peroxide solution was started at 15 ppm/Hr in terms of hydrogen peroxide relative to the polyvinyl chloride resin, and the average chlorine consumption rate was adjusted to 0.01 kg/PVC-kg·5 min. Then, when the amount of added chlorine reached 10.6% by mass, the supply of hydrogen peroxide solution and chlorine gas was terminated, whereby chlorination was terminated.

Subsequently, unreacted chlorine was removed by nitrogen gas aeration, and the obtained chlorinated polyvinyl chloride resin slurry was neutralized with sodium hydroxide, washed with water, dehydrated, and dried, whereby a powdery, thermally chlorinated polyvinyl chloride resin (amount of added chlorine: 10.6% by mass) was obtained.

### EXAMPLE 2

A glass-lined reaction vessel having an inner capacity of 300 L was charged with 130 kg of ion-exchanged water and 50 kg of a polyvinyl chloride resin having an average degree of polymerization of 700. They were stirred to disperse the polyvinyl chloride resin in water to prepare an aqueous suspension, and then the inside of the reaction vessel was heated to raise the temperature of the aqueous suspension to 70° C. Subsequently, the oxygen was removed (oxygen content 100 ppm) by reducing the pressure in the reaction vessel, and then the suspension was irradiated with UV light with a wavelength of 365 nm using a high-pressure mercury light at an irradiation intensity of 350 W, while stirring using an impeller at a uniformity of kinetic energy per volume in stirring of 0.383 kg/m/s². Thus, chlorination reaction was started. The reaction vessel was equipped with a baffle, and the ratio of the baffle distance to the impeller size (baffle distance/impeller size) in stirring was 1.130 (mm/mm).

Then, the chlorination temperature was kept at 70° C., the partial pressure of chlorine was kept at 0.04 MPa, and the average chlorine consumption rate was adjusted to 0.01 kg/PVC-kg·5 min. When the amount of added chlorine reached 10.5% by mass, the UV irradiation using the high-pressure mercury lamp and the chlorine gas supply were terminated, whereby chlorination was terminated.

Subsequently, unreacted chlorine was removed by nitrogen gas aeration, and the obtained chlorinated polyvinyl chloride resin slurry was neutralized with sodium hydroxide, washed with water, dehydrated, and dried, whereby a powdery, photo-chlorinated polyvinyl chloride resin (amount of added chlorine: 10.5% by mass) was obtained.

### EXAMPLES 3 TO 5, 7 TO 9, 11, AND 13 AND COMPARATIVE EXAMPLES 2, 3, 6, 7, AND 9

A powdery chlorinated polyvinyl chloride resin was obtained as in Example 1, except that the average degree of polymerization and amount of the raw material polyvinyl chloride resin added, the amount of ion-exchanged water added, and the chlorination conditions were changed as shown in Table 1.

### EXAMPLES 6, 10, AND 12

A powdery chlorinated polyvinyl chloride resin was obtained as in Example 2, except that the average degree of polymerization and amount of the raw material polyvinyl chloride resin added, the amount of ion-exchanged water added, and the chlorination conditions were changed as shown in Table 1.

### COMPARATIVE EXAMPLE 1

A glass-lined reaction vessel having an inner capacity of 300 L was charged with 130 kg of ion-exchanged water and 50 kg of a polyvinyl chloride resin having an average degree of polymerization of 700. They were stirred to disperse the polyvinyl chloride resin in water to prepare an aqueous suspension, and then the inside of the reaction vessel was heated to raise the temperature of the aqueous suspension to 70° C. Subsequently, the oxygen was removed (oxygen content 100 ppm) by reducing the pressure in the reaction vessel, and then the suspension was irradiated with UV light with a wavelength of 365 nm using a high-pressure mercury light at an irradiation intensity of 350 W, while stirring using an impeller at a uniformity of kinetic energy per volume in stirring of 0.090 kg/m·s². Thus, chlorination reaction was started. The reaction vessel was equipped with a baffle, and the ratio of the baffle distance to the impeller size (baffle distance/impeller size) in stirring was 0.210 (mm/mm).

Then, the chlorination temperature was kept at 70° C., the partial pressure of chlorine was kept at 0.04 MPa, and the average chlorine consumption rate was adjusted to 0.02 kg/PVC-kg·5 min. When the amount of added chlorine reached 10.5% by mass, the UV irradiation using the high-pressure mercury lamp and the chlorine gas supply were terminated, whereby chlorination was terminated.

Subsequently, unreacted chlorine was removed by nitrogen gas aeration, and the obtained chlorinated polyvinyl chloride resin slurry was neutralized with sodium hydroxide, washed with water, dehydrated, and dried, whereby a powdery, photo-chlorinated polyvinyl chloride resin (amount of added chlorine: 10.5% by mass) was obtained.

### COMPARATIVE EXAMPLES 4, 5, AND 8

A powdery chlorinated polyvinyl chloride resin was obtained as in Comparative Example 1, except that the average degree of polymerization and amount of the raw material polyvinyl chloride resin added, the amount of ion-exchanged water added, and the chlorination conditions were changed as shown in Table 1.

### Evaluation

The chlorinated polyvinyl chloride resins obtained in the examples and the comparative examples were evaluated as follows. Table 1 shows the results.

### (1) Measurement of Amount of Added Chlorine

The amount of added chlorine was measured for the obtained chlorinated polyvinyl chloride resins in conformity with JIS K 7229.

### (2) Molecular Structure Analysis

The molecular structure of the obtained chlorinated polyvinyl chloride resins was analyzed by the NMR measurement method described in R. A. Komoroski, R. G. Parker, J. P. Shocker, Macromolecules, 1985, 18, 1257-1265, to determine the amounts of vinyl chloride units and perchlorinated units.

The NMR measurement conditions were as follows.
Apparatus: FT-NMRJEOLJNM-AL-300
Measured nuclei: 13C (proton complete decoupling)
Pulse width: 90° PD: 2.4 sec
Solvent: o-dichlorobenzene: deuterated benzene (C5D5)=3:1
Sample concentration: about 20%
Temperature: 110° C.
Reference material: central signal for benzene set to 128 ppm
Number of scans: 20,000

### (3) Symmetry Factor Measurement

### High-Performance Liquid Chromatography [HPLC] Measurement

The obtained chlorinated polyvinyl chloride resin was adjusted to a concentration of 5 mg/mL using acetonitrile and tetrahydrofuran as solvents (acetonitrile/tetrahydrofuran=7/3 [volume ratio]). Thus, a measurement sample was obtained.

The measurement devices were as follows: a HPLC device (available from Shimadzu Corporation, a high-pressure gradient HPLC system Prominence); a HPLC column (available from Waters, XBridge® C8 [inner diameter 4.6 mm×length 150 mm, filler particle size 3.5 μm]); and an evaporative light scattering detector (available from Shimadzu Corporation, ELSD_LTII).

The analysis was performed as follows.

Acetonitrile was used as a mobile phase a, and tetrahydrofuran was used as a mobile phase b. At first, the inside of the HPLC device was filled with a solvent mixture at a mobile phase a/mobile phase b volume ratio of 7/3. The measurement sample was injected into the device in this state (injection volume: 10 μL). From immediately after the sample injection, the proportion of the mobile phase b in the mobile phase was increased at a constant rate (5 vol %/min) over 12 minutes. From 12 minutes after the sample injection (at this time, the mobile phase is completely replaced with the mobile phase b), the mobile phase b was run for 6 minutes. The column temperature was 45° C., and the total delivery flow rate was 0.6 mL/min. Nitrogen gas was used as the nebulizer gas for the evaporative light scattering detector. The gas supply pressure was 350 kPa, and the drift tube temperature was 40° C. The baseline was determined by analyzing a blank test solution, which was prepared in the same manner as the analysis sample except that a chlorinated polyvinyl chloride resin was dissolved.

### Calculation of Symmetry Factor and Half Width

The symmetry factor (W_{0.05h}/2f) was measured by reversed-phase partition gradient high-performance liquid chromatography using an acetonitrile-tetrahydrofuran eluent based on JIS K 0124 (2011). W_{0.05h} represents the peak width at the 5% peak height ( 1/20 of the height). f represents the distance from the peak start point to the point where a perpendicular line drawn from the peak top to the horizontal axis bisects the peak width W_{0.05h}. Specifically, the following were measured: the peak width (W_{0.05h}) at the 5% height (height from the baseline to the 1/20 of the peak height) of a measurement peak measured by the HPLC analysis under the above conditions; and the distance (f) from the peak start point at the peak width at the 5% height of the measurement peak to the intersection of a horizontal line passing through the peak start point and a perpendicular line passing through the peak top. The symmetry factor (W_{0.05h}/2f) was calculated from these values.

The symmetry factor was calculated for each of the peak observed in the retention time range from 2 to 4 minutes (symmetry factor A) and the peak observed in the retention time range from 10 to 18 minutes (symmetry factor B), and the ratio (A/B) of the symmetry factor A to the symmetry factor B was calculated.

Further, the half width (half width AW_{0.5}) of the peak observed in the retention time range from 2 to 4 minutes and the half width (half width BW_{0.5}) of the peak observed in the retention time range from 10 to 18 minutes were each measured, and then the half width ratio (AW_{0.5}/BW_{0.5}) was calculated.

### (4) Izod Impact Value

### Production of Chlorinated Polyvinyl Chloride Resin Composition

An amount of 5.0 parts by mass of an impact resistance modifier was added to 100 parts by mass of the obtained chlorinated polyvinyl chloride resin. Then, 2.0 parts by mass of a thermal stabilizer was added and mixed. The impact resistance modifier used was Kane Ace B-564 (available from Kaneka Corporation, methyl methacrylate-butadiene-styrene copolymer). The thermal stabilizer used was TVS #1380 (available from Nitto Kasei Co., Ltd., organotin stabilizer).

Further, 0.5 parts by mass of a polyethylene lubricant (available from Mitsui Chemicals, Inc., Hiwax 220MP) and 0.5 parts by mass of a fatty acid ester lubricant (available from Emery Oleochemicals Japan Ltd., LOXIOL G-32) were added. They were then uniformly mixed in a super mixer to prepare a chlorinated polyvinyl chloride resin composition.

### Measurement of Izod Impact Value [Before Testing]

The obtained chlorinated polyvinyl chloride resin composition was supplied to two 8-inch rolls and kneaded at 205° C. for three minutes to provide 1.0-mm-thick sheets. The obtained sheets were stacked and pre-heated with a press at 205° C. for three minutes and then pressurized for four minutes to provide a 3-mm-thick pressed plate. A specimen was cut out of the obtained pressed plate by machining. This specimen was used to measure the Izod impact value [before testing] in conformity with ASTM D256.

### Immersion Evaluation Test Under Acidic, High-Temperature, High-Pressure Conditions, Measurement of Izod Impact Value [After Testing], and Calculation of Rate of Decrease in Izod Impact Value

The specimen obtained above was immersed in hydrochloric acid at a pH of 1 at 80° C. for four weeks under nitrogen pressure (0.2 MPa). The specimen was then taken out and dried by heating at 60° C. for 24 hours (immersion evaluation test under acidic, high-temperature, high-pressure conditions). For the specimen after the immersion evaluation test under acidic, high-temperature, high-pressure conditions, the Izod impact value [after testing] was measured by the method described above. From the obtained Izod impact value [before testing] and Izod impact value [after testing], the rate of decrease in Izod impact value was calculated by the following formula.

Rate of decrease in impact resistance (%)=[(Izod impact value [before testing]−Izod impact value [after testing])/Izod impact value [before testing]]×100

### (5) Change in Thickness Before and After Immersion Evaluation Test Under Acidic, High-Temperature, High-Pressure Conditions

The thickness [before testing] of the specimen obtained in (Measurement of Izod impact value [before testing]) was measured with a caliper. Similarly, the thickness [after testing] of the specimen obtained in (Measurement of Izod impact value [after testing], calculation of rate of decrease in Izod impact value) was measured. From the thickness [before testing] and the thickness [after testing], the change in thickness before and after the immersion evaluation test under acidic, high-temperature, high-pressure conditions was calculated and evaluated in accordance with the following criteria.
o (Good): Change in thickness before and after testing of less than 0.2 mm
Δ (Fair): Change in thickness before and after testing of 0.2 mm or greater and less than 0.5 mm
x (Poor): Change in thickness before and after testing of 0.5 mm or greater

TABLE 1

| | | | | Example | | | | | | | |
|---|---|---|---|---|---|---|---|---|---|---|---|
| | | | | 1 | 2 | 3 | 4 | 5 | 6 | 7 | 8 |
| Production | Raw material | Average degree of | | 700 | 700 | 450 | 1900 | 1000 | 1000 | 700 | 700 |
| method | PVC | polymerization | | | | | | | | | |
| | | Amount fed | kg | 50 | 50 | 45 | 40 | 50 | 50 | 50 | 55 |
| | Water | Ion-exchanged water | kg | 130 | 130 | 150 | 120 | 100 | 130 | 130 | 210 |
| | Chlorination | Reaction temperature | ° C. | 100 | 70 | 100 | 105 | 100 | 65 | 100 | 100 |
| | conditions | Reaction pressure | Mpa | 0.4 | 0.04 | 0.4 | 0.4 | 0.4 | 0.04 | 0.4 | 0.4 |
| | | PVC + Water | kg | 180 | 180 | 195 | 160 | 150 | 180 | 180 | 265 |
| | | Reaction vessel | L | 300 | 300 | 300 | 300 | 300 | 300 | 300 | 300 |
| | | capacity | | | | | | | | | |
| | | (PVC + Water)/ | Kg/L | 0.600 | 0.600 | 0.650 | 0.533 | 0.500 | 0.600 | 0.600 | 0.883 |
| | | Reaction vessel | | | | | | | | | |
| | | capacity | | | | | | | | | |
| | | Baffle distance/ | mm/mm | 1.107 | 1.130 | 1.185 | 1.233 | 0.736 | 0.815 | 1.201 | 1.319 |
| | | Impeller size | | | | | | | | | |
| | | Uniformity of kinetic | kg/m/s² | 0.380 | 0.383 | 0.398 | 0.399 | 0.307 | 0.330 | 0.386 | 0.426 |
| | | energy per volume | | | | | | | | | |
| | | Average chlorine | kg/pvc- | 0.01 | 0.01 | 0.01 | 0.005 | 0.01 | 0.01 | 0.007 | 0.01 |
| | | consumption rate | kg · 5 min | | | | | | | | |
| | | 200 ppm Hydrogen | ppm/hr | 15 | — | 15 | 35 | 5 | — | 100 | 150 |
| | | peroxide | | | | | | | | | |
| | | UV wavelength | nm | — | 365 | — | — | — | 365 | — | — |
| CPVC | Amount of added chlorine | | mass % | 10.6 | 10.5 | 10.3 | 10.9 | 4.6 | 5.6 | 10.5 | 12.0 |
| | Amount of vinyl chloride unit | | mol % | 38.2 | 37.9 | 43.8 | 41.5 | 63.5 | 62.0 | 43.0 | 37.2 |
| | Amount of perchlorinated unit | | mol % | 49.3 | 49.7 | 44.2 | 45.1 | 36.4 | 37.8 | 44.5 | 46.6 |
| | Other structural units | | mol % | 12.5 | 12.4 | 12.0 | 13.5 | 0.1 | 0.2 | 12.5 | 16.2 |
| | Structural unit (b) | | mol % | 0.59 | 0.59 | 0.57 | 0.62 | 0.11 | 0.19 | 0.59 | 0.71 |
| | Structural unit (e) | | mol % | 1.30 | 1.30 | 1.29 | 1.31 | 1.06 | 1.10 | 1.30 | 1.36 |
| | HPLC | Symmetry factor A | | 2.77 | 2.76 | 2.75 | 2.79 | 2.36 | 2.43 | 2.76 | 2.86 |
| | | Symmetry factor B | | 0.87 | 0.86 | 0.76 | 0.75 | 0.88 | 0.85 | 0.76 | 0.74 |
| | | Symmetry factor ratio (A/B) | | 3.19 | 3.20 | 3.62 | 3.72 | 2.70 | 2.86 | 3.65 | 3.90 |
| | | (Amount of added chlorine)^{1/3} × | | 79.30 | 16.72 | 16.45 | 17.26 | 9.29 | 10.49 | 16.72 | 18.79 |
| | | (Symmetry factor A)² | | | | | | | | | |
| | | [Symmetry factor ratio (A/B)] × | | 29.65 | 29.65 | 24.83 | 47.31 | 34.32 | 34.48 | 30.11 | 30.35 |
| | | (Average degree of | | | | | | | | | |
| | | polymerization)^{1/2} | | | | | | | | | |
| | | (Symmetry factor B ) + | | 2.53 | 2.53 | 2.42 | 2.42 | 2.41 | 2.41 | 2.42 | 2.43 |
| | | (Symmetry factor A)^{1/2} | | | | | | | | | |
| | | Half width AW_{0.5} | | 0.25 | 0.25 | 0.25 | 0.26 | 0.18 | 0.19 | 0.25 | 0.27 |
| | | Half width BW_{0.5} | | 0.56 | 0.60 | 0.54 | 0.58 | 0.31 | 0.35 | 0.55 | 0.64 |
| | | Half width ratio (AW_{0.5}/BW_{0.5}) | | 0.45 | 0.42 | 0.45 | 0.44 | 0.56 | 0.55 | 0.45 | 0.42 |
| Molded | Izod impact | Izod impact value | J/m | 28.0 | 27.5 | 8.8 | 187.9 | 87.8 | 85.2 | 36.3 | 23.2 |
| body | value | [before testing] | | | | | | | | | |
| | | Izod impact value | J/m | 27.4 | 26.9 | 8.7 | 184.6 | 84.4 | 82.5 | 35.8 | 22.6 |
| | | [after testing] | | | | | | | | | |
| | | Rate of decrease in | % | 2.1 | 2.3 | 1.3 | 1.8 | 3.8 | 3.2 | 1.5 | 2.6 |
| | | Izod impact value | | | | | | | | | |
| | Change in | Thickness [before | mm | 3.01 | 3.05 | 3.01 | 3.05 | 3.00 | 3.02 | 3.01 | 3.02 |
| | thickness | testing] | | | | | | | | | |
| | | Thickness [after | mm | 2.91 | 2.87 | 2.96 | 2.98 | 2.85 | 2.89 | 2.95 | 2.92 |
| | | testing] | | | | | | | | | |
| | | Change in thickness | mm | 0.10 | 0.18 | 0.05 | 0.07 | 0.15 | 0.13 | 0.06 | 0.10 |
| | | Evaluation | — | ◯ | ◯ | ◯ | ◯ | ◯ | ◯ | ◯ | ◯ |

| | | | | | | | | | Comparative | |
|---|---|---|---|---|---|---|---|---|---|---|
| | | | | Example | | | | | Example | |
| | | | | 9 | 10 | 11 | 12 | 13 | 1 | 2 |
| Production | Raw material | Average degree of | | 800 | 1000 | 1000 | 600 | 1000 | 700 | 350 |
| method | PVC | polymerization | | | | | | | | |
| | | Amount fed | kg | 50 | 50 | 50 | 50 | 50 | 50 | 50 |
| | Water | Ion-exchanged water | kg | 150 | 150 | 150 | 150 | 150 | 130 | 150 |
| | Chlorination | Reaction temperature | ° C. | 100 | 80 | 115 | 105 | 85 | 70 | 110 |
| | conditions | Reaction pressure | Mpa | 0.4 | 0.04 | 0.2 | 0.03 | 0.4 | 0.04 | 0.4 |
| | | PVC + Water | kg | 200 | 200 | 200 | 200 | 200 | 180 | 200 |
| | | Reaction vessel | L | 300 | 300 | 300 | 600 | 1000 | 300 | 300 |
| | | capacity | | | | | | | | |
| | | (PVC + Water)/ | Kg/L | 0.667 | 0.667 | 0.667 | 0.333 | 0.200 | 0.600 | 0.667 |
| | | Reaction vessel | | | | | | | | |
| | | capacity | | | | | | | | |
| | | Baffle distance/ | mm/mm | 1.572 | 1.201 | 1.193 | 1.209 | 1.201 | 0.210 | 0.523 |
| | | Impeller size | | | | | | | | |
| | | Uniformity of kinetic | kg/m/s² | 0.449 | 0.394 | 0.393 | 0.395 | 0.394 | 0.090 | 0.294 |
| | | energy per volume | | | | | | | | |
| | | Average chlorine | kg/pvc- | 0.01 | 0.01 | 0.01 | 0.01 | 0.01 | 0.02 | 0.03 |
| | | consumption rate | kg · 5 min | | | | | | | |
| | | 200 ppm Hydrogen | ppm/hr | 350 | — | 45 | — | 70 | — | 100 |
| | | peroxide | | | | | | | | |
| | | UV wavelength | nm | — | 365 | — | 365 | — | 365 | — |
| CPVC | Amount of added chlorine | | mass % | 15.2 | 10.5 | 10.4 | 10.6 | 10.5 | 10.5 | 9.0 |
| | Amount of vinyl chloride unit | | mol % | 24.8 | 43.0 | 43.4 | 42.6 | 43.0 | 37.9 | 48.9 |
| | Amount of perchlorinated unit | | mol % | 51.0 | 44.5 | 44.4 | 44.7 | 44.5 | 50.1 | 42.5 |
| | Other structural units | | mol % | 24.2 | 12.5 | 12.2 | 12.7 | 12.5 | 12.0 | 8.7 |
| | Structural unit (b) | | mol % | 0.97 | 0.59 | 0.58 | 0.59 | 0.59 | 1.49 | 1.39 |
| | Structural unit (e) | | mol % | 1.48 | 1.30 | 1.29 | 1.30 | 1.30 | 1.52 | 0.85 |
| | HPLC | Symmetry factor A | | 3.01 | 2.76 | 2.76 | 2.77 | 2.76 | 2.76 | 2.66 |
| | | Symmetry factor B | | 0.71 | 0.76 | 0.76 | 0.75 | 0.76 | 1.56 | 1.16 |
| | | Symmetry factor ratio (A/B) | | 4.25 | 3.65 | 3.64 | 3.67 | 3.65 | 1.77 | 2.29 |
| | | (Amount of added chlorine)^{1/3} × | | 22.00 | 16.72 | 16.58 | 16.85 | 16.72 | 9.36 | 14.73 |
| | | (Symmetry factor A)² | | | | | | | | |
| | | [Symmetry factor ratio (A/B)] × | | 32.54 | 35.28 | 35.26 | 28.16 | 35.28 | 28.23 | 21.00 |
| | | (Average degree of | | | | | | | | |
| | | polymerization)^{1/2} | | | | | | | | |
| | | (Symmetry factor B ) + | | 2.44 | 2.42 | 2.42 | 2.42 | 2.42 | 3.22 | 2.79 |
| | | (Symmetry factor A)^{1/2} | | | | | | | | |
| | | Half width AW_{0.5} | | 0.30 | 0.25 | 0.25 | 0.25 | 0.25 | 0.25 | 0.23 |
| | | Half width BW_{0.5} | | 0.78 | 0.55 | 0.55 | 0.56 | 0.55 | 25.01 | 0.92 |
| | | Half width ratio (AW_{0.5}/BW_{0.5}) | | 0.38 | 0.45 | 0.45 | 0.45 | 0.45 | 0.01 | 0.25 |
| Molded | Izod impact | Izod impact value | J/m | 23.8 | 72.6 | 72.9 | 23.1 | 72.6 | 29.0 | 17.7 |
| body | value | [before testing] | | | | | | | | |
| | | Izod impact value | J/m | 22.8 | 71.5 | 71.8 | 22.7 | 71.5 | 26.5 | 16.2 |
| | | [after testing] | | | | | | | | |
| | | Rate of decrease in | % | 4.2 | 1.5 | 1.4 | 1.6 | 1.5 | 8.6 | 8.4 |
| | | Izod impact value | | | | | | | | |
| | Change in | Thickness [before | mm | 3.01 | 3.04 | 3.03 | 3.02 | 3.01 | 3.04 | 3.02 |
| | thickness | testing] | | | | | | | | |
| | | Thickness [after | mm | 2.84 | 2.98 | 2.97 | 2.96 | 2.95 | 2.48 | 2.69 |
| | | testing] | | | | | | | | |
| | | Change in thickness | mm | 0.17 | 0.06 | 0.06 | 0.06 | 0.06 | 0.56 | 0.33 |
| | | Evaluation | — | ◯ | ◯ | ◯ | ◯ | ◯ | X | Δ |

| | | | | Comparative Example | | | | | | |
|---|---|---|---|---|---|---|---|---|---|---|
| | | | | 3 | 4 | 5 | 6 | 7 | 8 | 9 |
| Production | Raw material | Average degree of | | 2300 | 1000 | 850 | 1000 | 1000 | 1000 | 700 |
| method | PVC | polymerization | | | | | | | | |
| | | Amount fed | kg | 55 | 50 | 45 | 35 | 25 | 50 | 50 |
| | Water | Ion-exchanged water | kg | 160 | 150 | 170 | 40 | 123 | 150 | 150 |
| | Chlorination | Reaction temperature | ° C. | 100 | 70 | 65 | 95 | 100 | 90 | 125 |
| | conditions | Reaction pressure | Mpa | 0.4 | 0.02 | 0.04 | 0.4 | 0.4 | 0.04 | 0.4 |
| | | PVC + Water | kg | 215 | 200 | 215 | 75 | 148 | 200 | 200 |
| | | Reaction vessel | L | 300 | 300 | 300 | 300 | 300 | 300 | 300 |
| | | capacity | | | | | | | | |
| | | (PVC + Water)/ | Kg/L | 0.717 | 0.667 | 0.717 | 0.250 | 0.493 | 0.667 | 0.667 |
| | | Reaction vessel | | | | | | | | |
| | | capacity | | | | | | | | |
| | | Baffle distance/ | mm/mm | 0.560 | 0.070 | 2.713 | 0.650 | 1.570 | 1.924 | 0.390 |
| | | Impeller size | | | | | | | | |
| | | Uniformity of kinetic | kg/m/s² | 0.298 | 0.227 | 0.638 | 0.272 | 0.481 | 0.501 | 0.274 |
| | | energy per volume | | | | | | | | |
| | | Average chlorine | kg/pvc- | 0.04 | 0.06 | 0.07 | 0.04 | 0.07 | 0.06 | 0.04 |
| | | consumption rate | kg · 5 min | | | | | | | |
| | | 200 ppm Hydrogen | ppm/hr | 100 | — | — | 100 | 100 | 100 | 100 |
| | | peroxide | | | | | | | | |
| | | UV wavelength | nm | — | 365 | 365 | — | — | 365 | — |
| CPVC | Amount of added chlorine | | mass % | 9.7 | 0.5 | 17.5 | 10.0 | 4.8 | 16.0 | 6.5 |
| | Amount of vinyl chloride unit | | mol % | 46.1 | 74.0 | 15.9 | 45.0 | 65.1 | 21.7 | 58.6 |
| | Amount of perchlorinated unit | | mol % | 43.4 | 22.2 | 54.2 | 43.8 | 33.8 | 52.1 | 39.0 |
| | Other structural units | | mol % | 10.5 | 3.8 | 30.0 | 11.2 | 1.1 | 26.2 | 2.4 |
| | Structural unit (b) | | mol % | 1.43 | 0.84 | 1.94 | 1.45 | 1.12 | 1.84 | 1.23 |
| | Structural unit (e) | | mol % | 0.90 | 0.18 | 1.90 | 0.93 | 0.52 | 1.82 | 0.65 |
| | HPLC | Symmetry factor A | | 2.71 | 2.09 | 3.24 | 2.73 | 2.38 | 3.14 | 2.49 |
| | | Symmetry factor B | | 1.13 | 2.16 | 0.55 | 1.05 | 0.52 | 0.56 | 1.31 |
| | | Symmetry factor ratio (A/B) | | 2.40 | 0.97 | 5.90 | 2.59 | 4.58 | 5.59 | 1.90 |
| | | (Amount of added chlorine)^{1/3} × | | 15.65 | 3.45 | 27.22 | 16.05 | 9.53 | 24.78 | 11.59 |
| | | (Symmetry factor A)² | | | | | | | | |
| | | [Symmetry factor ratio (A/B)] × | | 50.36 | 32.59 | 35.05 | 34.21 | 36.20 | 37.22 | 28.36 |
| | | (Average degree of | | | | | | | | |
| | | polymerization)^{1/2} | | | | | | | | |
| | | (Symmetry factor B ) + | | 2.78 | 3.60 | 2.35 | 2.71 | 2.06 | 2.33 | 2.89 |
| | | (Symmetry factor A)^{1/2} | | | | | | | | |
| | | Half width AW_{0.5} | | 0.24 | 0.13 | 0.34 | 0.24 | 0.18 | 0.32 | 0.20 |
| | | Half width BW_{0.5} | | 0.89 | 21.94 | 0.37 | 0.81 | 0.27 | 0.37 | 1.12 |
| | | Half width ratio (AW_{0.5}/BW_{0.5}) | | 0.27 | 0.01 | 0.92 | 0.30 | 0.67 | 0.86 | 0.18 |
| Molded | Izod impact | Izod impact value | J/m | 210.9 | 98.3 | 15.0 | 73.9 | 87.3 | 58.5 | 71.1 |
| body | value | [before testing] | | | | | | | | |
| | | Izod impact value | J/m | 194.0 | 85.4 | 13.1 | 68.1 | 83.0 | 51.5 | 64.1 |
| | | [after testing] | | | | | | | | |
| | | Rate of decrease in | % | 8.0 | 13.1 | 12.9 | 7.8 | 4.9 | 12.0 | 9.8 |
| | | Izod impact value | | | | | | | | |
| | Change in | Thickness [before | mm | 3.01 | 3.08 | 3.04 | 3.01 | 2.98 | 3.02 | 3.03 |
| | thickness | testing] | | | | | | | | |
| | | Thickness [after | mm | 2.69 | 2.56 | 2.52 | 2.70 | 2.78 | 2.54 | 2.64 |
| | | testing] | | | | | | | | |
| | | Change in thickness | mm | 0.32 | 0.52 | 0.52 | 0.31 | 0.20 | 0.48 | 0.39 |
| | | Evaluation | — | Δ | X | X | Δ | Δ | Δ | Δ |

### INDUSTRIAL APPLICABILITY

The present invention can provide a chlorinated polyvinyl chloride resin, a resin composition for molding, and a molded body that are capable of suppressing a change in thickness and a decrease in impact resistance when contacting acidic liquid at high temperature and high pressure.

1. A chlorinated polyvinyl chloride resin having a ratio (A/B) of a symmetry factor A to a symmetry factor B of 2.61 or greater and 4.50 or less in high-performance liquid chromatography measurement, the symmetry factor A being a symmetry factor of a peak observed in a retention time range from 2 to 4 minutes, the symmetry factor B being a symmetry factor of a peak observed in a retention time range from 10 to 18 minutes.

2. The chlorinated polyvinyl chloride resin according to claim 1, including perchlorinated units in an amount of 23.0 mol % or more and 65.0 mol % or less.

3. The chlorinated polyvinyl chloride resin according to claim 1, containing added chlorine in an amount of 3.3% by mass or more and 15.3% by mass or less.

4. The chlorinated polyvinyl chloride resin according to claim 1, having a C calculated by the following formula (1) of 7.0 or greater and 25.0 or less:
C=(Amount of added chlorine)^{1/3}×(Symmetry factor A)² (1).

5. A resin composition for molding, comprising the chlorinated polyvinyl chloride resin according to claim 1.

6. A molded body produced using the resin composition for molding according to claim 5.
